(19) United States
(12) Patent Application Publication
(10) Pub. No.: US 2007/0159106 A1
(43) Pub. Date: Jul. 12, 2007

(54) COLLECTOR IN MICROWAVE TUBE

(75) Inventor: Hiroshi TSUCHIDA, Sagamihara-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC MICROWAVE TUBE, LTD., Kanagawa (JP)

(21) Appl. No.: 11/620,459

(22) Filed: Jan. 5, 2007

(30) Foreign Application Priority Data
Jan. 11, 2006 (JP) 2006-003744

(51) Int. Cl. H01J 25/34

(52) U.S. Cl. 315/39.3

(57) ABSTRACT

A collector in a microwave tube has a collector electrode for capturing an electron beam radiated from an electron gun and passing through a slow wave circuit, an insulator disposed in contact with the outer peripheral surface of the collector electrode, and a radiator disposed in contact with the outer peripheral surface of the insulator, wherein the insulator, the outer diameter of the collector electrode, and the inner diameter of the radiator are tapered in the axial direction of the tube.

This application is based upon and claims the benefit of priority from Japanese Patent Application No. 2006-003744 filed on Jan. 11, 2006, the content of which is incorporated by reference.

### BACKGROUND OF THE INVENTION

1. Field of the Invention:

The present invention relates to a collector in a microwave tube for capturing an electron beam radiated from an electron gun and passing through a slow wave circuit.

2. Description of the Related Art:

FIG. 1 is a cross-sectional view illustrating the structure of a general microwave tube.

Referring to FIG. 1, the general microwave tube comprises electron gun 51 for emitting an electron beam, slow wave circuit 52 for handling interaction between an RF signal (microwave) applied thereto and the electron beam emitted from electron gun 51 for amplification to deliver the amplified electron beam therefrom, collector 53 for capturing the electron beam which has passed through slow wave circuit 52, and anode electrode 54 for guiding the electron beam emitted from electron gun 51 into slow wave circuit 52.

Collector 53 captures an electron beam at a collector electrode and converts motion energy of the captured electron beam to thermal energy. Therefore, the collector electrode is subjected to an immense amount of heat and is applied with a high voltage.

To address this problem, some microwave tubes employ a collector which has a collector electrode covered with an insulator for increasing the withstand voltage, and which dissipates heat generated in the collector electrode to a heat sink disposed outside the insulator (see, for example, Patent Documents 1-5).

Patent Document 1: JP-A-U-05-087788;

Patent Document 2: JP-A-05-275018;

Patent Document 3: JP-A-07-045207;

Patent Document 4: JP-A-2003-162965; and

Patent Document 5: JP-A-2005-093176.

In the following, a description will be given of the structure of this type of conventional collector.

FIG. 2A is a longitudinal sectional view illustrating the structure of a collector in a conventional microwave tube, and FIG. 2B is a cross-sectional view taken along line A-A′ in FIG. 2A.

Referring to FIGS. 2A and 2B, collector 4 in the conventional microwave tube comprises collector electrodes 41 (collector electrodes 41a, 41b in the figures), insulator 42, and radiator 43. In collector 4, cylindrical insulator 42 made of ceramic or the like is disposed in contact with the outer peripheral surface of collector electrode 41 for covering collector electrode 41.

Also, in order to increase the withstand voltage, collector electrode 41 must be entirely covered with insulator 42. For this reason, parts of insulator 42 protrude from the creepage surfaces of collector electrodes 41. In the following, the total length of a top surface, a bottom surface, and a side surface of the protruding part of insulator 42 is called the “creeping discharge distance.” It should be noted that an excessive increase in the creeping discharge distance would result in an increase in the size of collector 4, and a consequent increase in the size of the entire microwave tube. Accordingly, the creeping discharge distance is reduced within an allowable range in order to achieve both an increase in the withstand voltage and preventing an increase in the size of collector 4.

Radiator 43 made of a metal or the like is disposed in contact with the outer peripheral surface of insulator 42 on the upper and lower sides in FIGS. 2A and 2B, and heat sink 3 is disposed outside lower radiator 43 in contact therewith. Thus, as collector electrodes 41 capture an electron beam which has passed through slow wave circuit 2 to cause heat to be generated therein, the heat is guided from insulator 42 to radiator 43, and is further dissipated to heat sink 3.

Insulator 42 is partially formed with slot 45 along the axial direction of the tube in order to increase the heat radiation effect. But on the contrary, slot 45 causes deterioration contact between insulator 42 and collector electrode 41 and between insulator 42 and radiator 43. As such, radiator 43 is designed to serve as a member which uses a fastening structure with screws 44, such that radiator 43 is fastened by screws 44 to bring insulator 42 into closer contact with collector electrode 41 and radiator 43.

In collector 4 of the conventional microwave tube illustrated in FIGS. 2A and 2B, an electron beam is generally captured at a site X that is located deepest area in collector 4. However, the electron beam is also captured at sites Y in addition to site X when the microwave tube is turned ON/OFF or when an RF signal applied to slow wave circuit 2 is turned ON/OFF. This causes a displacement of the heat source in collector electrode 41 from which heat is generated.

While insulator 42 is fastened by screws 44 to be in contact with collector electrodes 41 and radiator 43, insulator 42 is susceptible to a shift in the axial direction of the tube due to a difference in the coefficients of thermal expansion among the components, because of its simple cross-sectional profile of a cylinder.

Therefore, the aforementioned displacement of the heat source in collector electrodes 41 would cause an associated shift of insulator 42 in the axial direction of the tube, resulting in a shorter creeping discharge distance on one of the upstream and downstream sides in the electron beam traveling direction, and a possible failure to keep the creeping discharge distances uniform. In this event, collector electrode 41 cannot be sufficiently covered with insulator 42, resulting in a lower withstand voltage.

### SUMMARY OF THE INVENTION

It is therefore an object of the present invention to provide a collector in a microwave tube which is capable of preventing a degradation of a withstand voltage.

To achieve the above object, a collector in a microwave tube of the present invention has a collector electrode for capturing an electron beam radiated from an electron gun and passing through a slow wave circuit, an insulator disposed in contact with the outer peripheral surface of the collector electrode, and a radiator disposed in contact with the outer peripheral surface of the insulator, wherein the insulator, the outer diameter of the collector electrode, and the inner diameter of the radiator are tapered in the axial direction of the tube.

According to this configuration, the insulator is tapered in the axial direction of the tube, so that even if a displacement of a heat source in the collector electrode would ordinarily cause the insulator to shift in the axial direction of the tube, the insulator is prevented from shifting so that the insulator is stopped at a certain position by the collector electrode or radiator which is in contact with the inner peripheral or outer peripheral surface of the insulator. Accordingly, even if a displacement of the heat source in the collector electrode may ordinarily cause the insulator to shift in the axial direction of the tube, the insulator is stopped at a certain position, thus making it possible to maintain the creeping discharge distance of the insulator constant to thereby prevent a degradation of the withstand voltage.

The insulator is preferably tapered in the axial direction of the tube such that the insulator has a diameter which is increasingly smaller toward the downstream side in an electron beam traveling direction.

According to this configuration, when the insulator is disposed after the collector electrode and radiator have been disposed behind the slow wave circuit in the manufacturing of the collector, the insulator can be readily inserted from the downstream side in the electron beam traveling direction for disposition.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a cross-sectional view illustrating the structure of a general microwave tube;

FIG. 2A is a longitudinal sectional view illustrating a collector in a conventional microwave tube;

FIG. 2B is a cross-sectional view taken along line A-A′ in FIG. 2A;

FIG. 3A is a longitudinal sectional view illustrating the structure of a collector in a microwave tube according to one embodiment of the present invention; and

FIG. 3B is a cross-sectional view taken along line A-A′ in FIG. 3A.

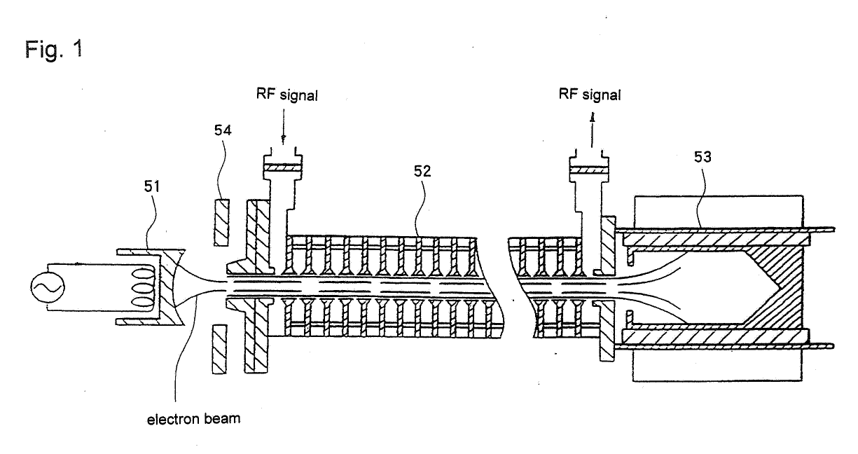

### DESCRIPTION OF THE PREFERRED EMBODIMENTS

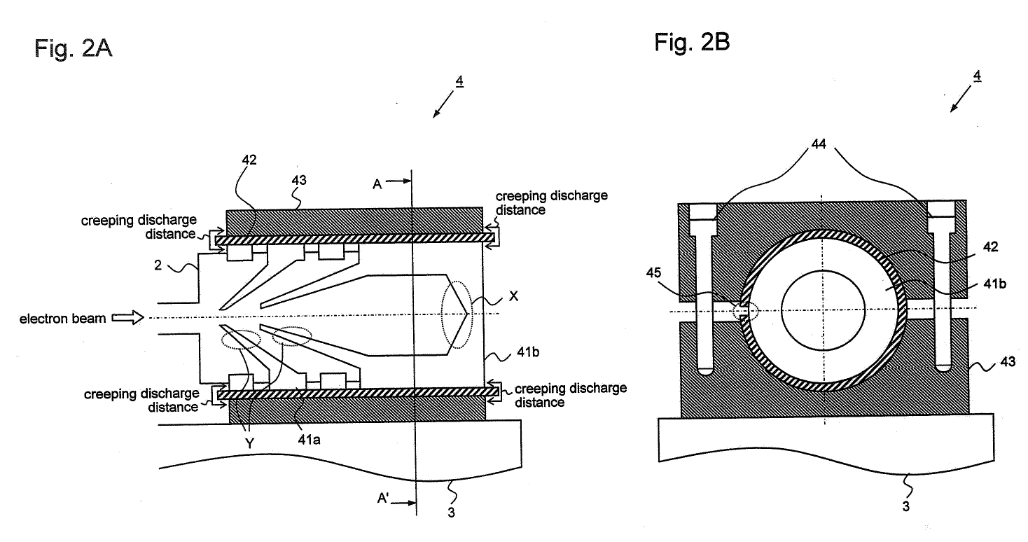

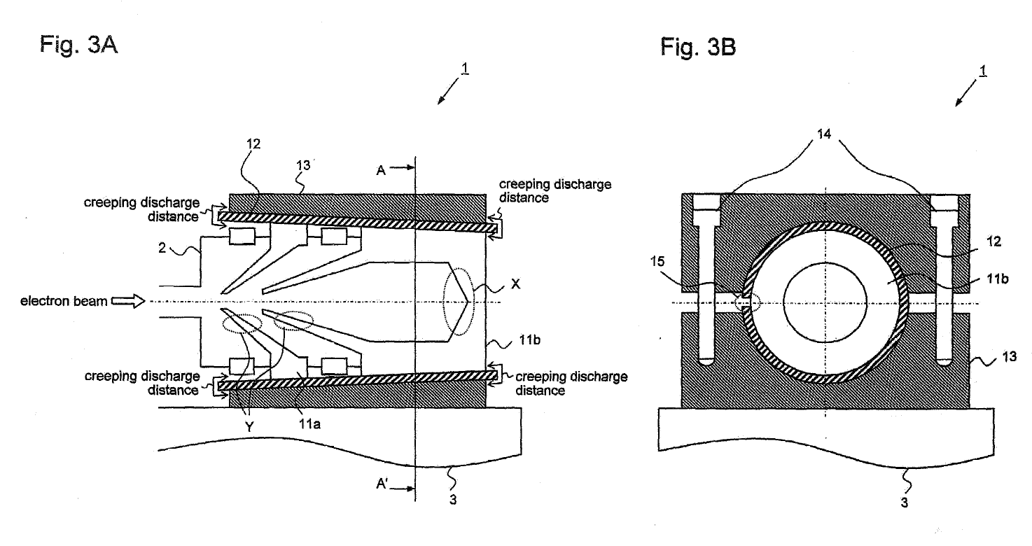

FIG. 3A is a longitudinal sectional view illustrating the structure of a collector in a microwave tube according to one embodiment of the present invention, and FIG. 3B is a cross-sectional view taken along line A-A′ in FIG. 3A. In FIGS. 3A and 3B, components identical to those in FIGS. 2A and 2B are designated the same reference numerals.

Referring to FIGS. 3A and 3B, collector 1 in the microwave tube according to this embodiment comprises collector electrodes 11 (collector electrodes 11a, 11b in the figures), insulator 12, and radiator 13. In collector 1, insulator 12 which covers collector electrode 11 has a conical configuration which is tapered in the axial direction of the tube.

As in a conventional collector, the creeping discharge distance of insulator 12 protruding from the creepage surface of each collector electrode 11 is reduced within an allowable range in collector 1, as well, in order to completely cover collector electrodes 11 with insulator 12.

Heat sink 3 is also disposed outside radiator 13 on the lower side of the FIGS. 3A and 3B in contact with radiator 13. Therefore, heat generated in collector electrodes 11 is guided from insulator 12 to radiator 13, and is further dissipated to heat sink 3.

Also, insulator 12 is partially formed with slot 15 along the axial direction of the tube in order to increase the heat radiation effect. In addition, radiator 13 is designed to serve as a member which uses a fastening structure with screws 14, such that radiator 13 is fastened by screws 14 to bring insulator 12 into closer contact with collector electrode 11 and radiator 13.

As in a conventional microwave tube, the electron beam is also captured at sites Y in addition to site X when the microwave tube is turned ON/OFF or when an RF signal applied to slow wave circuit 2 is turned ON/OFF, causing a displacement of the heat source in collector electrodes 11. Thus, when the heat source in collector electrode 11 is displaced, insulator 12 tends to shift in the axial direction of the tube.

However, insulator 12 has a conical configuration which is tapered so that its diameter is increasingly smaller toward the downstream side in the electron beam traveling direction. With this structure, even if insulator 12 is going to shift upstream in the electron beam traveling direction, collector electrode 1 1 prevents insulator 12 from shifting, so that insulator 12 is stopped at a certain position. Also, even if insulator 12 is going to shift downstream in the electron beam traveling direction, radiator 13 prevents insulator 12 from shifting, so that insulator 12 is stopped at a certain position.

Accordingly, even if a displacement of the heat source in collector electrodes 11 would ordinarily cause insulator 12 to shift in the axial direction of the tube, insulator 12 is stopped at a certain position, thus making it possible to maintain the creeping discharge distance of insulator 12 constant to thereby prevent a degradation of the withstand voltage.

In this embodiment, insulator 12 has a conical configuration which is tapered to have an increasingly smaller diameter toward the downstream side in the electron beam traveling direction. Alternatively, insulator 12 may be made in a conical configuration which is tapered to have an increasingly smaller diameter toward the upstream side in the electron beam traveling direction.

However, collector 1 is generally manufactured by first placing collector electrode 11 and radiator 13 behind slow wave circuit 2 and then disposing insulator 12. In this event, when insulator 12 is inserted from the upstream side in the electron beam traveling direction for disposition, slow wave circuit 2 is a hindrance that will cause difficulties in disposing insulator 12. Accordingly, insulator 12 should be inserted from the downstream side in the electron beam traveling direction for disposition. Therefore, in order to facilitate the insertion of the insulator from the downstream side in the electron beam traveling direction, insulator 12 is preferably made in a conical tube configuration which is tapered to have an increasingly smaller diameter toward the downstream side in the electron beam traveling direction, as illustrated in FIGS. 3A and 3B.

Also, while the collector of the foregoing embodiment has two collector electrodes 11a, 11b as illustrated in FIG. 3, the collector may have a single or multiple collector electrodes 11 to provide similar advantages.

While preferred embodiments of the present invention have been described using specific terms, such description is for illustrative purposes only, and it is to be understood that changes and variations may be made without departing from the spirit or scope of the following claims.

What is claimed is:

1. A collector in a microwave tube comprising:
a collector electrode for capturing an electron beam radiated from an electron gun and passing through a slow wave circuit;
an insulator disposed in contact with the outer peripheral surface of said collector electrode; and
a radiator disposed in contact with the outer peripheral surface of said insulator,
wherein said insulator, the outer diameter of said collector electrode, and the inner diameter of said radiator are tapered in an axial direction of the tube.

2. The collector in a microwave tube according to claim 1, wherein said insulator is tapered in the axial direction of the tube such that said insulator has a diameter which is increasingly smaller toward the downstream side in an electron beam traveling direction.
